(19) United States
(12) Patent Application Publication
(10) Pub. No.: US 2006/0030341 A1
(43) Pub. Date: Feb. 9, 2006

(54) Mobile desk phone

(75) Inventor: Kim Oanh Pham, Marlboro, NJ (US)

Correspondence Address: COHEN, PONTANI, LIEBERMAN & PAVANE, 551 FIFTH AVENUE, SUITE 1210, NEW YORK, NY, 10176, US

(73) Assignee: Avaya Technology Corp.

(21) Appl. No.: 10/913,261

(22) Filed: Aug. 6, 2004

(51) Int. Cl. H04Q 7/20

(52) U.S. Cl. 455/462; 455/465

(57) ABSTRACT

A communication device includes a stationary phone connectable to a wired telephone network and a removable wireless unit. The stationary phone and wireless unit are provided with a means of a two-way wireless interface. In one embodiment, the wireless unit further includes a built-in multi-functional personal organizer and an optional means of connectivity to a cellular phone network.

### BACKGROUND OF THE INVENTION

1. Field of the Invention

The present invention generally relates to a field of communication devices and, in particular, to portable communication devices coupled to wired telephone networks.

2. Description of the Related Art

In the typical modern business environment, a worker is usually provided with a combination of individual communication devices and scheduling/information tools, including a desk phone for in-office voice communications, a wireless phone for out-of-office two-party communications, and a personal organizer. Typically, the desk and wireless phones are each connected to separately operated respective wired and wireless corporate networks, while the personal organizer is used as a stand-alone device that may also be connected to a worker's computer.

However, for video conferencing and out-of-office multi-party voice conferencing or for communicating both voice and graphical information, the worker will require specialized communication devices. Furthermore, conventional personal organizers mostly do not have means of connectivity to telephone networks supporting the desk phone or the wireless phone. These limitations of available means of corporate communications inevitably have negative effect on efficiency of exchanging business information and, as such, on the productivity of the worker.

Therefore, there is a need in the art for an improved communication device which is particularly useful for the business environment.

### SUMMARY OF THE INVENTION

The present invention generally relates to a field of communication devices for use over wired telephone networks, such as public switched telephone networks (PSTN), telephone networks using the Internet Protocol (IP), local (e.g., corporate) telephone area networks (LANs), and the like.

In one aspect of the present invention, there is provided a communication device comprising a removable (i.e., mobile) wireless unit, and a stationary phone connectable to a wired telephone network. The stationary phone and the wireless unit are coupled to each other using a two-way wireless interface. In one embodiment, the wireless unit has voice, video, and multi-media conferencing communication capabilities and includes a multi-functional organizer having a touch-screen display.

In another aspect of the invention, the wireless unit is additionally adapted for interfacing with a cellular phone network, thus allowing the wireless unit to function as a stand-alone cellular phone.

Further aspects of the invention include a computer-readable medium containing the software that facilitates operation of the communication device and a wired telephone network supporting communication devices having the removable wireless units.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

The teachings of the present invention will become apparent by considering the following detailed description in conjunction with the accompanying drawings, in which:

FIG. 1 depicts a block diagram of an exemplary communication device in accordance with one embodiment of the present invention; and

FIG. 2 depicts a top plan view of one illustrative embodiment of a stationary phone and a wireless unit of the communication device of FIG. 1.

Herein, identical reference numerals are used, where possible, to designate identical elements that are common to the figures.

The appended drawings illustrate exemplary embodiments of the invention and, as such, should not be considered limiting the scope of the invention that may admit to other equally effective embodiments.

### DETAILED DESCRIPTION OF THE PRESENTLY PREFERRED EMBODIMENTS

The present invention generally relates to a field of communication devices coupled to wired telephone networks, such as public switched telephone networks (PSTNs) including Plain Old Telephone Service (POTS) networks, telephone networks using the Internet Protocol (IP), corporate local area networks (LANs), and the like. Embodiments of the invention allow combining a desk phone, a wireless phone, and a multi-functional personal organizer in a single multi-media communication device.

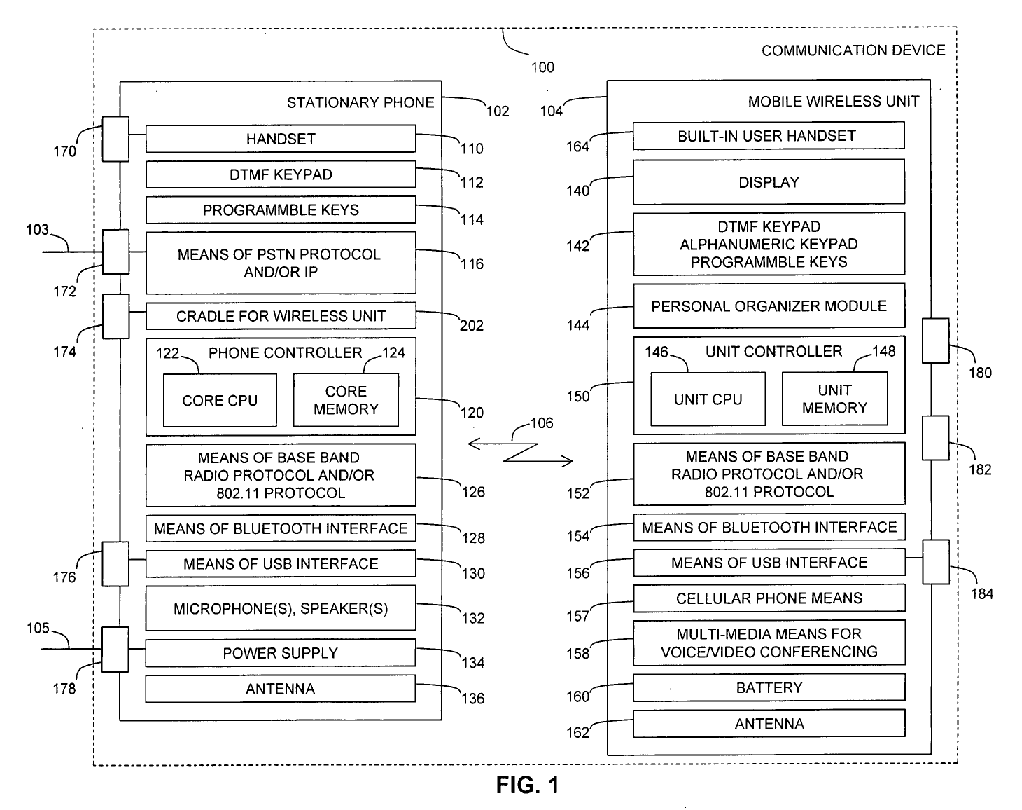

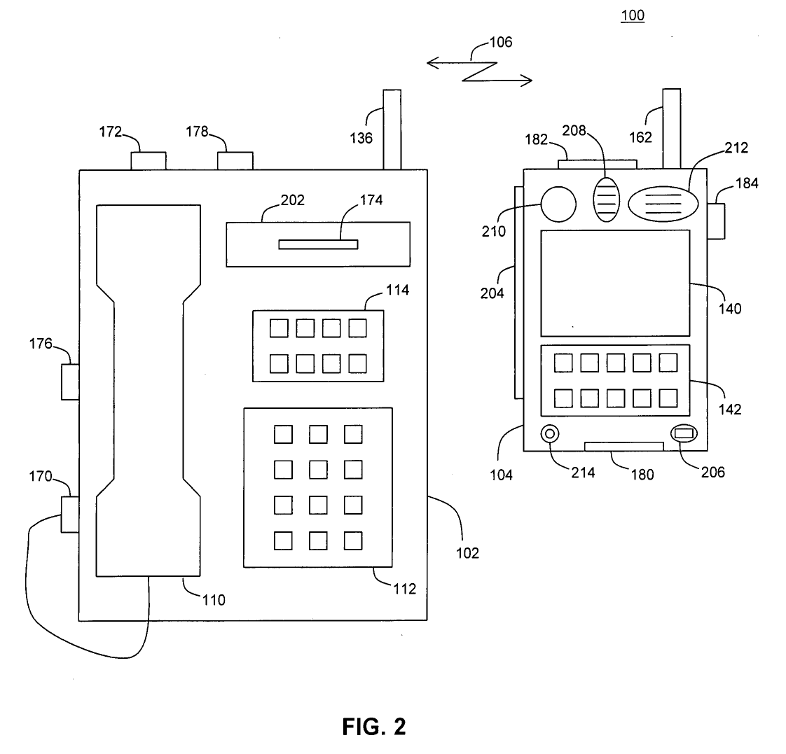

FIG. 1 depicts a block diagram of an exemplary communication device 100 in accordance with one embodiment of the present invention. The device 100 generally comprises a stationary phone component 102 and docking station or receptacle 202 for seating a removable, or mobile, wireless unit 104 (FIG. 2). The stationary phone component 102 integrates a desk phone coupled to a PSTN (not shown) with a wireless base. The wireless base supports two-way wireless communication with the wireless unit 104. In operation, the wireless unit 104 performs as a multi-functional wireless phone and shares a common dial in number with the stationary phone 102. Preferably, the wireless unit 104 comprises a personal digital assistant (PDA) or a built-in personal organizer, and provides for multi-media communication and conferencing capabilities.

In one exemplary embodiment, the stationary phone 102 comprises a phone controller 120, a means 116 of a PSTN protocol and/or the IP, a user handset 110, at least one dual tone multi-frequency (DTMF) keypad 112 (one DTMF keypad is shown), an optional set 114 of programmable keys (e.g., “Conference”, “Transfer”, “Hold”, “Redial”, and the like fixed features), the docking station 202 for the wireless unit 104, a means 126 of a base band radio protocol (900 MHz and/or 2.45 GHz) and/or a 802.11 protocol specification, a power supply 134, and an antenna 136 for providing wireless communication with the wireless unit 104. In the depicted embodiment, the stationary phone 102 further includes an optional plurality of built-in or remote microphone(s) and speaker(s) 132 for multi-party conferencing, as well as optional means 128 and 130 of the Bluetooth and the Universal Serial Bus (USB) interfaces (or protocols), respectively.

Herein, the term “802.11 protocol specification” collectively refers to a family of specifications for wireless local area networks (WLANs). These specifications use the Ethernet protocol and a carrier sense multiple access with collision avoidance (CSMA/CA) protocol for path sharing. There are currently four specifications in the family: 802.11, 802.11a, 802.11b, and 802.11g. The term “Internet Protocol” refers to a method of sending and receiving data via the Internet, including digitized audible data (e.g., digitized voice messages, digitized music, and the like); and the term “PSTN protocol” refers to the analog and/or digital interface between the stationary phone 102 and a nearest switch (not shown) of the wired telephone network comprising the stationary phone. The term “protocol” is further interchangeably used for designating hardware and software means facilitating the corresponding method of communication.

The phone controller 120 facilitates operation of the stationary phone 102 and administers a two-way wireless interface 106 between the stationary phone and the wireless unit 104. The interface 106 may be used to transmit multi-media information (e.g., audible, graphical, video, and numeric messages), as well as control signals (e.g., dial in, ring, programming, on/off, and the like).

In one embodiment, the phone controller 120 includes a core CPU 122 (e.g., microprocessor based CPU) and a core memory 124. The core memory 124 may include various types of non-volatile, programmable, and random access electronic memory, such as flash memory, magnetic random access memory (MRAM), static random access memory (SRAM), dynamic random access memory (DRAM), and the like.

Illustratively, a wired interface 103 (e.g., twisted pair(s), coaxial cable, and the like) to a PSTN or IP network (both not shown) and a power interface 105 to a source of electric power (e.g., electric power outlet (not shown)) are coupled, via connectors 172 and 178, to the means 116 and the power supply 134, respectively. The docking station, also referred to herein as a cradle, 202 is mechanically adapted for housing the wireless unit 104 and includes a cradle connector 174.

When the wireless unit 104 is placed in the cradle 202, the connector 174, via a mating connector 180 of the wireless unit, couples the power supply 134 to the wireless unit 104 to charge/recharge a battery 160 of the wireless unit. Additionally, when coupled together, the cradle connector 174 and connector 180 may provide optional wired connectivity for communicating control signals and data between the wireless unit and the stationary phone 102.

As depicted, the stationary phone also includes a handset connector 170 and a USB connector 176, each such connector coupled to a respective functional module. The USB connector 176 provides a means of optional interface to a remote computer (not shown) that may be used for programming the stationary phone 102 and/or the wireless unit 104. When the wireless unit 104 is disposed in the cradle 202, the USB connector 176 may also be used for downloading, via the cradle connector 174, information or programming instructions to/from the wireless unit 104.

The phone controller 120, the means 116, 126, 128, and 130, as well as other components of the stationary phone 102 excluding the cradle 202, may be reduced to practice in a form of application specific integrated circuits (ASICs), an assembly of commercially available functional modules, or a combination thereof. Corresponding functional modules are fabricated by, e.g., Motorola Inc. of Schaumburg, Ill. and Lucent Technologies Inc. of Murray Hill, N.J., among other suppliers.

In one exemplary embodiment, the wireless unit 104 comprises a unit controller 150, a multi-line display 140, a means 164 of a built-in handset including a microphone and a user speaker, a combination 142 of at least one of a DTMF keypad, an alphanumeric keypad, and a set of programmable keys (e.g., “Conference”, “Transfer”, “Hold”, “Redial”, and the like fixed features), a personal organizer module 144, a means 152 of the base band radio protocol (900 MHz and/or 2.45 GHz) and/or 802.11 specification, the battery 160, and an antenna 162 for communicating with the stationary phone 102.

In the depicted embodiment, the wireless unit 104 further comprises optional modules including a multi-media means 158 for voice and/or video conferencing, a means 154 of the Bluetooth interface, a means 156 of the USB interface having a USB connector 184, and a slot 182 for an industry-standard memory card (e.g., flash memory card). The wireless unit 104 may also comprise known in the art means 157 of cellular phone connectivity for wirelessly communicating data (e.g., voice, text, and/or graphical data) to cellular devices in communication with a cellular network using at least one of time-division multiple access (TDMA), code-division multiple access (CDMA), and global system for mobile communication (GSM) wireless protocols or any other known or hereinafter developed techniques. Switching between the wireless (e.g., 2.45 GHz) mode and the cellular phone mode of operation can be accomplished manually by using a mode switch 214 (shown in FIG. 2) or, alternatively, the wireless unit 104 may automatically switch to the “cellular” mode when it detects, in any known manner, that it is out of range with the stationary phone 102. Components of the wireless unit 104 may be implemented as ASICs, an assembly of commercially available functional modules, or a combination thereof.

The unit controller 150 of the wireless unit 104 includes a microprocessor based unit CPU 146 and a unit memory 148 and facilitates operation of the wireless unit 104. Together with the core controller 120, the unit controller 150 administers the two-way wireless interface 106 between the unit 104 and the stationary phone 102. Similar to the core memory 124, the unit memory 148 may include flash memory, MRAM, SRAM, DRAM, and the like means of data storage. The unit memory 148 may further be supplemented by the optional memory card (not shown) comprising additional memory space and/or built-in programs for optional or updated features of the wireless unit 104 or the personal organizer module 144.

In one embodiment, the wireless unit 104 has a touch-screen display 140 and is further supplied with a stylus 204 (shown in FIG. 2 below). In this embodiment, either the entire combination 142 or portions of the combination (e.g., DTMF keypad and/or alphanumeric keypad) may be displayed (i.e., mapped) and accessible, as executable keys or symbols, on the touch-screen display 140. In operation, the display 140 may be used to enter and/or display numeric, alphanumeric, graphical, and video messages and data, as well as provide a user with programming and status information.

The module 144 is generally a micro-processor based multi-functional personal organizer having, for example, scheduling, calculating, address book(s), task list(s), e-mail box(es), and voice mail box(es) capabilities, among other features. In operation, the personal organizer module 144 uses the display 140 for displaying and/or entering information. The user data displayed on the display 140 and/or stored in the personal organizer module 144 may be available, via the wireless interface 106 and/or the cradle connector 174, to the stationary phone 102.

Alternatively, such a data may be available, via the USB connector 184, to a remote computer (not shown) or a wireless unit of another user connected to the same telephone network. In a further embodiment, computing and data storing functions of the personal organizer module 144 may be performed using resources in the unit controller 150, and, as such, the module 144 is optional.

The multi-media means 158 may comprise built-in video camera(s), microphone(s) and speaker(s) adapted for data exchange and/or multi-party conferencing, as well as a means of connectivity to external devices having such capabilities.

In one embodiment, in a mobile configuration of the communication device 100 (i.e., when the wireless unit 104 and the stationary phone 102 are separated from one another), the means 126 and 152 provide wireless connectivity between the stationary phone 102 and the wireless unit 104. Alternatively, the wireless connectivity may be provided using the means 128 (stationary phone 102) and 154 (wireless unit 104) of the Bluetooth interface. In a further embodiment, each of the wireless unit 104 and the stationary phone 102 may comprise both the means 126/128 and the means 152/154, respectively. In this embodiment, a specific communication protocol may be selected by a user or, automatically, by the phone controller 120 based on, e.g., transmission properties of a path between the wireless unit and the stationary phone.

User selectable features of the communication device 100 (e.g., an ON/OFF of the stationary phone 102 or the wireless unit 104, an ON/OFF of ringing, a number of rings before re-routing the caller to a mail box or disconnecting, and the like) may be associated with either one of or, optionally, both the stationary phone and the wireless unit.

FIG. 2 depicts a top plan view of one illustrative embodiment of the stationary phone 102 and the wireless unit 104 of the communication device of FIG. 1. In a desk (i.e., stationary) configuration, the wireless unit 104 is placed in the receptacle 202 of the stationary phone 102 such that the cradle connector 174 becomes electrically coupled to the connector 180 of the wireless unit 102.

For illustrative purposes, the communication device 100 is shown in a mobile configuration when the wireless unit 104 is removed from the receptacle 202. In the depicted embodiment, the wireless unit 102 comprises the combination 142 having a set of programmable keys, however, in an alternate embodiment, such keys may be mapped on the touch-screen display 140. In this alternate embodiment, the wireless unit 104 comprises a microphone 206 and a user speaker 208, and the multi-media means 158 include a built-in video camera 210 and a speaker 212 for mobile conferencing. Using the mode switch 214, the user can select between wired and cellular phone modes of operation.

Thus, while there have been shown and described and pointed out fundamental novel features of the present invention as applied to preferred embodiments thereof, it will be understood that various omissions and substitutions and changes in the form and details of the devices described and illustrated, and in their operation, and of the methods described may be made by those skilled in the art without departing from the spirit of the present invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is the intention, therefore, to be limited only as indicated by the scope of the claims appended hereto.

I claim:

1. A communication device, comprising:
a stationary phone connectable to a wired telephone network; and
a removable wireless unit selectively coupled to the stationary phone using a wireless interface to provide the wireless unit with wireless access to the wired telephone network, the wireless unit being configured for receiving chargeable operating power from the stationary phone.

2. The device of claim 1 wherein the stationary phone and the wireless unit share a common dial in number.

3. The device of claim 1 wherein the stationary phone comprises a means of wireless communicating to the wireless unit, a cradle for receiving the wireless unit, the cradle having a connector for electrical coupling to the wireless unit, a user handset, and at least one dual tone multi-frequency (DTMF) keypad.

4. The device of claim 3 wherein a power supply of the stationary phone recharges a battery of the wireless unit when the wireless unit is positioned in said cradle.

5. The device of claim 1 wherein the wireless unit comprises a means of wireless communicating to the stationary phone, a connector for electrical coupling to the stationary phone, and a display,

6. The device of claim 5 wherein the wireless unit comprises a personal organizer and wherein the display is coupled to the personal organizer.

7. The device of claim 5 wherein the display is a touch-screen display.

8. The device of claim 7 wherein the touch-screen display displays, in an executable format, at least one of a dual tone multi-frequency (DTMF) keypad, an alphanumeric keypad, and programmable keys.

9. The device of claim 1 wherein the stationary phone is compliant with at least one of a public switched telephone network (PSTN) protocol and the Internet Protocol (IP).

10. The device of claim 1 wherein the wireless interface supports communicating of at least one of voice messages, numeric messages, graphical messages, and video messages, and a combination thereof.

11. The device of claim 1 wherein the wireless interface uses at least one communication protocol selected from the group consisting of a base band radio (900 MHz and/or 2.45 GHz) protocol, the 802.11 protocol, the 802.11a protocol, the 802.11b protocol, the 802.11g protocol, and the Bluetooth protocol.

12. The device of claim 1 wherein at least one of the wireless unit and the stationary phone further comprises a means of the Universal Serial Bus (USB) interface to a remote computer or a remote communication device.

13. The device of claim 1 wherein the wireless unit comprises a built-in means for multimedia conferencing.

14. The device of claim 1 wherein the wireless unit is adapted for coupling to an external means for multimedia conferencing.

15. The device of claim 1 wherein at least one of the stationary phone and the wireless unit comprises a speaker and a microphone for hands-free access.

16. The device of claim 1 wherein the wired telephone network is one of a public switched telephone network (PSTN), a telephone network using the Internet Protocol (IP), and a corporate local area network (LAN).

17. The device of claim 1 wherein the wireless unit further comprises a means for selective wireless connectivity to cellular devices in communication with a cellular phone network.

18. A communication device, comprising:
a stationary phone connectable to a wired telephone network; and
a removable wireless unit selectively coupled to the stationary phone using a wireless interface providing the wireless unit with wireless access to one of the wired telephone network and a cellular phone network.

19. The device of claim 18 wherein the wireless unit comprises a means for facilitating switching from the wired telephone network to the cellular phone network when the unit is out of range of the wired telephone network.

20. The device of claim 18 wherein the wireless unit comprises a personal organizer having a display accessible by the wireless unit.

21. The device of claim 20 wherein the personal organizer has built-in scheduling functionality.

22. A wired telephone network supporting at least one communication device, the communication device comprising:
a stationary phone connectable to the network; and
a removable wireless unit having a built-in personal organizer, wherein the stationary phone and the wireless unit are coupled using a wireless interface.

23. The network of claim 22 wherein the stationary phone and the wireless unit have the same dial in number.
